(19) United States
(12) Patent Application Publication
(10) Pub. No.: US 2018/0350317 A1
(43) Pub. Date: Dec. 6, 2018

(54) DISPLAY DEVICE

(71) Applicant: Samsung Display Co., Ltd., Yongin-si (KR)

(72) Inventors: Seung-Woon SHIN, Asan-si (KR); Sung-Jae PARK, Seongnam-si (KR); Kyung-Hun LEE, Yongin-si (KR)

(21) Appl. No.: 15/865,751

(22) Filed: Jan. 9, 2018

(30) Foreign Application Priority Data
Jun. 5, 2017 (KR) 10-2017-0069781

(51) Int. Cl. G09G 3/36; G02F 1/1343; G02F 1/1362

(52) U.S. Cl. CPC G09G 3/3696; G09G 2310/0264; G02F 1/136286; G02F 1/134336

(57) ABSTRACT

A display device includes a display unit that includes a plurality of unit areas, wherein each of the plurality of unit areas includes a plurality of pixels arranged in a matrix format, the plurality of pixels include a plurality of high-level pixels receiving a data voltage of relatively high luminance and a plurality of low-level pixels receiving a data voltage of relatively low luminance with respect to the same image data, and in the unit areas, high-level pixel pairs and low-level pixel pairs are alternately arranged in a row direction, and one high-level pixel and one low-level pixel are alternately arranged in a column direction.

### CROSS-REFERENCE TO RELATED APPLICATION

This application claims priority to and the benefit of Korean Patent Application No. 10-2017-0069781 filed in the Korean Intellectual Property Office on Jun. 5, 2017; the entire contents of the Korean Patent Application are incorporated herein by reference.

### BACKGROUND

### (a) Field

The technical field relates to a display device.

### (b) Description of the Related Art

A display device, such as a liquid crystal display, may include electrodes and a liquid crystal layer. The liquid crystal display may rearrange liquid crystal molecules in the liquid crystal layer by applying voltages to the electrodes and may thus control transmittance of light so as to display images.

The liquid crystal display may perform inversion driving for changing a direction of an electric field applied to the liquid crystal layer to thereby prevent deterioration of liquid crystals. Inversion driving is a driving method for changing a polarity of a data voltage applied to a data line at regular intervals. Inversion driving may undesirably cause crosstalk which causes an unwanted horizontal line or an unwanted vertical line to be seen on a screen, or flickering.

The above information disclosed in this Background section is for enhancement of understanding of related background. The Background section may contain information that does not form the prior art that is already known in this country to a person of ordinary skill in the art.

### SUMMARY

Embodiments may be related to a display device that has satisfactory display quality with minimum crosstalk or flickering.

A display device according to an embodiment includes a display unit that includes a plurality of unit areas, wherein each of the plurality of unit areas includes a plurality of pixels arranged in a matrix format, the plurality of pixels include a plurality of high-level pixels receiving a data voltage of relatively high luminance and a plurality of low-level pixels receiving a data voltage of relatively low luminance with respect to the same image data, and in the unit areas, high-level pixel pairs and low-level pixel pairs are alternately arranged in a row direction, and one high-level pixel and one low-level pixel are alternately arranged in a column direction.

Each of the plurality of unit areas may further include a plurality of data lines connected to the plurality of pixels and extending along corresponding pixel columns, and a plurality of pixels included in two adjacent pixel rows may be respectively connected to a data line of a first side among two adjacent opposite data lines and a plurality of pixels included in two other adjacent pixel rows that are adjacent to the two adjacent pixel rows may be connected to a data line of the second side among the two adjacent opposite data lines.

Each of the plurality of unit areas may further include a plurality of gate lines each extending in a row direction for one pixel row and connected to the plurality of pixels, and each of the plurality of pixels connected to the same gate line may be connected to a data line on the same side among the two adjacent opposite data lines.

Polarities of data voltages applied to two adjacent opposite data lines of the pixel columns may be different to each other.

The number of high-level pixels connected to a first data line where a positive data voltage is applied, the number of high-level pixels connected to a second data line where a negative data voltage is applied, the number of low-level pixels connected to the first data line, and the number of low-level pixels connected to the second data line may be equal to each other.

Each of the plurality of unit areas may include a plurality of pixels arranged in a matrix of 4 rows and 12 columns.

The plurality of high-level pixels may include a first high-level pixel displaying a first color, a second high-level pixel displaying a second color, and a third high-level pixel displaying a third color, and the plurality of low-level pixels may include a first low-level pixel displaying the first color, a second low-level pixel displaying the second color, and a third low-level pixel displaying the third color.

The plurality of pixels may be arranged in an order of the first color, the second color, and the third color in the row direction, and are arranged by the same color in the column direction.

Each of the first to third high-level pixels may be divided into a first sub-pixel of a high level and a second sub-pixel of a high level connected to the same gate line and the same data line, and each of the first to third low-level pixels may be divided into a first sub-pixel of a low level and a second sub-pixel of a low level connected to the same gate line and the same data line.

The first sub-pixel of the high level and the second sub-pixel of the high level may receive the same gate signal and the same data voltage, and the second sub-pixel of the high level may be charged with a relatively lower pixel voltage than the first sub-pixel of the high level.

The first sub-pixel of the low level and the second sub-pixel of the low level may receive the same gate signal and the same data voltage, and the second sub-pixel of the low may be is charged with a relatively lower pixel voltage than the first sub-pixel of the low level.

The first sub-pixel of the low level may display an image with luminance that is relatively lower than that of the second sub-pixel of the high level.

A display device according to another embodiment includes: a first gate line to a fourth gate line that are extended in a first direction and adjacent to each other; and a plurality of high-level pixels and a plurality of low-level pixels connected to the first to fourth gate lines, wherein high-level pixel pairs and low-level pixel pairs are alternately arranged in the first direction and connected to the first and third gate lines, low-level pixel pairs and high-level pixel pairs are alternately arranged in the first direction and connected to the second and fourth gate lines, and the plurality of high-level pixels receive a data voltage of relatively higher luminance than the plurality of low-level pixels with respect to the same image data.

The display device may further include a plurality of data lines connected to the plurality of high-level pixels and the plurality of low-level pixels, wherein a plurality of high-level pixels connected to the first gate line may be connected to the same data line to which a plurality of low-level pixels connected to the second gate line are connected, a plurality of low-level pixels connected to the first gate line may be connected to the same data line to which a plurality of high-level pixels connected to the second gate line are connected, a plurality of high-level pixels connected to the third gate line may be connected to the same data line to which a plurality of low-level pixels connected to the fourth gate line are connected, and a plurality of low-level pixels connected to the third gate line may be connected to the same data line to which a plurality of high-level pixels connected to the fourth gate line are connected.

A plurality of high-level pixels and a plurality of low-level pixels connected to the first gate line and the second gate line may be respectively connected to a data line of a first side among two adjacent opposite data lines, and a plurality of high-level pixels and a plurality of low-level pixels connected to the third gate line and the fourth gate line may be connected to a data line of a second side among the two adjacent opposite data lines.

Each of the plurality of high-level pixels may be divided into a first sub-pixel of a high level and a second sub-pixel of a high level connected to the same gate line and the same data line, and each of the plurality of low-level pixels may be divided into a first sub-pixel of a low level and a second sub-pixel of a low level connected to the same gate line and the same data line.

The first sub-pixel of the high level and the second sub-pixel of the high level may receive the same gate signal and the same data voltage, and the second sub-pixel of the high level may be charged with a relatively lower pixel voltage than the first sub-pixel of the high level.

The first sub-pixel of the low level and the second sub-pixel of the low level may receive the same gate signal and the same data voltage, and the second sub-pixel of the low level may be charged with a relatively lower pixel voltage than the first sub-pixel of the low level.

A display device according to another embodiment includes a plurality of pixels arranged in a matrix format and a display unit including a plurality of data lines connected to the plurality of pixels, wherein the display unit includes: a first pixel row including high-level pixel pairs and low-level pixel pairs that are connected to a data line of a first side among two opposite data lines and alternately arranged in a row direction; a second pixel row including low-level pixel pairs and high-level pixel pairs that are connected to the data line of the first side among the two opposite data lines and alternately arranged in the row direction; a third pixel row including high-level pixel pairs and low-level pixel pairs that are connected to a data line of a second side among the two opposite data lines and alternately arranged in the row direction; and a fourth pixel row including low-level pixel pairs and high-level pixel pairs that are connected to the data line of the second side among the two opposite data lines and alternately arranged in the row direction, and the high-level pixels among the plurality of pixels receive a data voltage of relatively higher luminance than the low-level pixels with respect to the same image data.

The high-level pixels may be divided into a first sub-pixel of a high level and a second sub-pixel of a high level connected to the same gate line and the same data line and the second sub-pixel of the high level may be charged with a relatively lower pixel voltage than the first sub-pixel of the high level, and the low-level pixels may be divided into a first sub-pixel of a low level and a second sub-pixel of a low level connected to the same gate line and the same data line and the second sub-pixel of the low level may be charged with a relatively lower pixel voltage than the first sub-pixel voltage of the low level.

An embodiment may be related to a display device. The display device may include high-level pixel pairs and low-level pixel pairs. The high-level pixel pairs may include first-row high-level pixel pairs and second-row high-level pixel pairs. The low-level pixel pairs may include first-row low-level pixel pairs and second-row low-level pixel pairs. Each pixel pair of the high-level pixel pairs and the low-level pixel pairs may consist of two pixels. With respect to same image data, each pixel of the high-level pixel pairs may receive a data voltage associated with luminance higher than luminance associated with a data voltage that an immediately neighboring pixel of the low-level pixel pairs is configured to receive. The first-row high-level pixel pairs and the first-row low-level pixel pairs may be alternately arranged in a first pixel row. The second-row low-level pixel pairs and the second-row high-level pixel pairs may be alternately arranged in a second pixel row. The second pixel row may immediately neighbor and extend parallel to the first pixel row. The first-row high-level pixel pairs may include a first-row high-level pixel positioned in a first pixel column. The second-row low-level pixel pairs may include a second-row low-level pixel positioned in the first pixel column and immediately neighboring the first-row high-level pixel.

The display device may include the following elements: a first data line positioned at a first side of the first pixel column; and a second data line positioned at a second side of the first pixel column opposite the first side of the first pixel column. The high-level pixel pairs may include third-row high-level pixel pairs and fourth-row high-level pixel pairs. The low-level pixel pairs may include third-row low-level pixel pairs and fourth-row low-level pixel pairs. The third-row high-level pixel pairs and the third-row low-level pixel pairs may be alternately arranged in a third pixel row immediately neighboring the second pixel row. The fourth-row low-level pixel pairs and the fourth-row high-level pixel pairs may be alternately arranged in a fourth pixel row immediately neighboring the third pixel row. The second pixel row may be positioned between the first pixel row and the third pixel row. The third pixel row may be positioned between the second pixel row and the fourth pixel row. The third-row high-level pixel pairs may include a third-row high-level pixel positioned in the first pixel column and immediately neighboring the second-row low-level pixel. The fourth-row low-level pixel pairs may include a fourth-row low-level pixel positioned in the first pixel column and immediately neighboring the third-row high-level pixel. Each of the first-row high-level pixel and the second-row low-level pixel may be electrically connected to the second data line. Each of the third-row high-level pixel and the fourth-row low-level pixel may be electrically connected to the first data line.

The device may include the following elements: a first gate line electrically connected to each pixel of the first-row high-level pixel pairs and each pixel of the first-row low-level pixel pairs; a second gate line electrically connected to each pixel of the second-row low-level pixel pairs and each pixel of the second-row high-level pixel pairs; a third gate line electrically connected to each pixel of the third-row high-level pixel pairs and each pixel of the third-row low-level pixel pairs; and a fourth gate line electrically connected to each pixel of the fourth-row low-level pixel pairs and each pixel of the fourth-row high-level pixel pairs.

The first data line may receive a first data voltage having a first polarity when the second data line receives a second data voltage having a second polarity. The first polarity may be opposite to the second polarity.

A total number of high-level pixels electrically connected to the first data line, a total number of high-level pixels electrically connected to the second data line, a total number of low-level pixels electrically connected to the first data line, and a total number of low-level pixels electrically connected to the second data line may be equal to one another. With respect to identical image data, each high-level pixel may receive a data voltage associated with luminance higher than luminance associated with a data voltage that each low-level pixel may receive.

The display device may include a plurality of unit areas, which may include a first unit area. Each of the unit areas may consist of 48 pixels arranged in 4 pixel rows and 12 pixel columns. The first unit area may include 12 pixels of the first pixel row and 12 pixels of the second pixel row.

The first-row high-level pixel pairs may include a first high-level pixel displaying a first color, a second high-level pixel displaying a second color, and a third high-level pixel displaying a third color. The first color, the second color, and the third color may be different from one another. The first-row low-level pixel pairs may include a first low-level pixel displaying the first color, a second low-level pixel displaying the second color, and a third low-level pixel displaying the third color. The third low-level pixel may immediately neighbor each of the second high-level pixel and the first low-level pixel and may be positioned between the second high-level pixel and the first low-level pixel, and

The first low-level pixel may be positioned between the third low-level pixel and the third high-level pixel.

A second pixel column may immediately neighbor the first pixel column. A third pixel column may immediately neighbor the second pixel column. The second pixel column may be positioned between the first pixel column and the third pixel column. All pixels in the first pixel column display the first color. All pixels in the second pixel column display the second color. All pixels in the third pixel column display the third color.

The display device may include the following elements: a first data line; a second data line immediately neighboring the first data line; a third data line immediately neighboring the second data line, wherein the second data line may be positioned between the first data line and the third data line; and a first gate line electrically connected to each pixel of the first pixel row and intersecting each of the first data line, the second data line, and the third data line. The first high-level pixel may include first two sub-pixels each electrically connected to the first gate line and each electrically connected to the first data line. The second high-level pixel may include second two sub-pixels each electrically connected to the first gate line and each electrically connected to the second data line. The third low-level pixel may include third two sub-pixels each electrically connected to the first gate line and each electrically connected to the third data line.

The first two sub-pixels may be respectively charged with first two unequal pixel voltages.

The third two sub-pixels may be respectively charged with second two unequal pixel voltages.

At least one of the third two sub-pixels may provide luminance lower than luminance provided by each of the first two sub-pixels.

The display device may include the following elements: a first gate line electrically connected to each pixel of the first-row high-level pixel pairs and each pixel of the first-row low-level pixel pairs; a second gate line electrically connected to each pixel of the second-row low-level pixel pairs and each pixel of the second-row high-level pixel pairs; a third gate line; and a fourth gate line. The high-level pixel pairs may include third-row high-level pixel pairs and fourth-row high-level pixel pairs. The low-level pixel pairs may include third-row low-level pixel pairs and fourth-row low-level pixel pairs. The third-row high-level pixel pairs and the third-row low-level pixel pairs may be alternately arranged in a third pixel row immediately neighboring the second pixel row. The fourth-row low-level pixel pairs and the fourth-row high-level pixel pairs may be alternately arranged in a fourth pixel row immediately neighboring the third pixel row. The second pixel row may be positioned between the first pixel row and the third pixel row. The third pixel row may be positioned between the second pixel row and the fourth pixel row. The third-row high-level pixel pairs may include a third-row high-level pixel positioned in the first pixel column and immediately neighboring the second-row low-level pixel. The fourth-row low-level pixel pairs may include a fourth-row low-level pixel positioned in the first pixel column and immediately neighboring the third-row high-level pixel. The third gate line may be electrically connected to each pixel of the third-row high-level pixel pairs and each pixel of the third-row low-level pixel pairs. The fourth gate line may be electrically connected to each pixel of the fourth-row low-level pixel pairs and each pixel of the fourth-row high-level pixel pairs.

The display device may include the following elements: a first data line positioned at a first side of the first pixel column; and a second data line positioned at a second side of the first pixel column opposite the first side of the first pixel column. Each of the first-row high-level pixel and the second-row low-level pixel may be electrically connected to the second data line. Each of the third-row high-level pixel and the fourth-row low-level pixel may be electrically connected to the first data line.

The first-row high-level pixel may be a first-row high-level first-color pixel. The second-row low-level pixel may be a second-row low-level first-color pixel. The third-row high-level pixel may be a third-row high-level first-color pixel. The fourth-row low-level pixel may be a fourth-row low-level first-color pixel. The third-row high-level pixel pairs may include a third-row high-level second-color pixel immediately neighboring the third-row high-level first-color pixel and electrically connected to the second data line. The fourth-row low-level pixel pairs may include a fourth-row low-level second-color pixel immediately neighboring the fourth-row low-level first-color pixel and electrically connected to the second data line.

The display device may include the following elements: a first data line intersecting each of the first gate line and the second gate line; and a second data line immediately neighboring the first data line and intersecting each of the first gate line and the second gate line. The first-row high-level pixel may include first two sub-pixels each electrically connected to the first gate line and each electrically connected to the second data line. The second-row low-level pixel may include second two sub-pixels each electrically connected to the second gate line and each electrically connected to the first data line.

The first two sub-pixels may be respectively charged with first two unequal pixel voltages.

The second two sub-pixels may be respectively charged with second two unequal pixel voltages.

The display device may include the following elements: a first data line positioned at a first side of the first pixel column; and a second data line positioned at a second side of the first pixel column opposite the first side of the first pixel column. The high-level pixel pairs may include a third-row high-level pixel positioned in the first pixel column, positioned in a third pixel row, and immediately neighboring the second-row low-level pixel. The low-level pixel pairs may include a fourth-row low-level pixel positioned in the first pixel column, positioned in a fourth pixel row, and immediately neighboring the third-row high-level pixel. Each of the first-row high-level pixel and the second-row low-level pixel may be electrically connected to the second data line. Each of the third-row high-level pixel and the fourth-row low-level pixel may be electrically connected to the first data line.

The display device may include the following elements: a first gate line; and a second gate line. The first-row high-level pixel may include first two sub-pixels each electrically connected to the first gate line, each electrically connected to the second data line, and configured to be respectively charged with first two unequal pixel voltages. The second-row low-level pixel may include second two sub-pixels each electrically connected to the second gate line, each electrically connected to the first data line, and configured to be respectively charged with second two unequal pixel voltages.

According to embodiments, a display device can provide satisfactory side visibility using high-level pixels and low-level pixels, and satisfactory screen display quality of the display device can be implemented by optimizing alignment of the high-level pixels and the low-level pixels and optimizing a connection structure with data lines.

### BRIEF DESCRIPTION OF THE DRAWINGS

FIG. 1 is a schematic block diagram of a display device according to an embodiment.

FIG. 2 is a block diagram of a plurality of unit areas of a display unit of FIG. 1 according to an embodiment.

FIG. 3 shows a configuration of a unit area of the display unit according to an embodiment.

FIG. 4 shows polarity inversion of a data voltage applied to a data line in the configuration of the unit area of FIG. 3 according to an embodiment.

FIG. 5 shows a pixel according to an embodiment.

FIG. 6 shows a configuration of a unit area of a display unit according to an embodiment.

FIG. 7 shows polarity inversion of a data voltage applied to a data line in the configuration of the unit area of FIG. 6 according to an embodiment.

FIG. 8 shows a pixel according to an embodiment.

### DETAILED DESCRIPTION

Example embodiments are described with reference to the accompanying drawings. As those skilled in the art would realize, the described embodiments may be modified in various ways.

Although the terms “first,” “second,” etc. may be used herein to describe various elements, these elements, should not be limited by these terms. These terms may be used to distinguish one element from another element. Thus, a first element may be termed a second element without departing from teachings of one or more embodiments. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-type (or first-set),” “second-type (or second-set),” etc., respectively.

The drawings and description are to be regarded as illustrative in nature and not restrictive. Like reference numerals may designate like elements.

In the drawings, thicknesses of layers, films, panels, regions, etc., may be exaggerated for clarity.

Unless explicitly described to the contrary, the word “comprise” and variations such as “comprises” or “comprising” may imply the inclusion of stated elements but not the exclusion of any other elements.

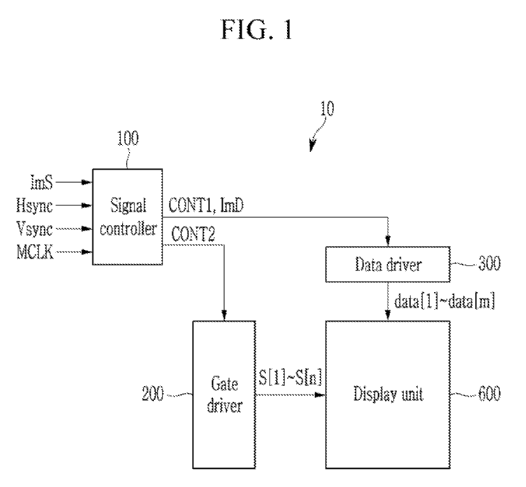

FIG. 1 is a schematic block diagram of a display device according to an embodiment.

Referring to FIG. 1, a display device 10 includes a signal controller 100, a gate driver 200, a data driver 300, and a display unit 600. The display device 10 may be a liquid crystal display (LCD), and may further include a backlight (not shown) that emits light toward the display unit 600.

The signal controller 100 receives an input image signal ImS and a synchronization signal input from an external device. The input image signal ImS includes luminance information of a plurality of pixels. Luminance has a predetermined number of gray levels, for example, 1024 (=2¹⁰), 256 (=2⁸) or 64 (=2⁶). The synchronization signal includes a horizontal synchronization signal Hsync, a vertical synchronization signal Vsync, and a main clock signal MCLK.

The signal controller 100 generates a first driving control signal CONT1, a second driving control signal CONT2, and an image data signal ImD according to the input video signal ImS, the horizontal synchronization signal Hsync, the vertical synchronization signal Vsync, and the main clock signal MCLK.

The signal controller 100 divides the input image signal ImS by frame units according to the vertical synchronization signal Vsync, and divides the input image signal ImS by gate line units according to the horizontal synchronization signal Hsync to generate the image data signal ImD. The signal controller 100 transmits the image data signal ImD and the first driving control signal CONT1 to the data driver 300. The signal controller 100 transmits the second driving control signal CONT2 to the gate driver 200.

The display unit 600 is a display area including a plurality of pixels. In the display unit 600, a plurality of gate lines that extend substantially in a row direction and are almost parallel with each other and a plurality of data lines that extend substantially in a column direction and are almost parallel with each other are formed to be connected to the pixels.

Each of the pixels may emit light of primary colors. The primary colors may include red, green, and blue, and the three primary colors are spatially or temporally combined to obtain a desired color. A color may be displayed by a red pixel, a green pixel, and a blue pixel, and the red pixel, the green pixel, and the blue pixel may be collectively referred to as one pixel.

The gate driver 200 is connected to the plurality of gate lines, and generates a plurality of gate signals S[1] to S[n] according to the second driving control signal CONT2. The gate driver 200 may sequentially apply a gate signal S[1] to S[n] of a gate-on voltage to a corresponding gate line.

The data driver 300 is connected to a plurality of data lines, performs sampling and holding on the image data signal ImD according to the first driving control signal CONT1, and transmits a plurality of data voltages data[1]-data[m] to a plurality of data lines. The data driver 300 is synchronized with a time when the plurality of gate signals S[1] to S[n] respectively become the gate-on voltage and thus applies the plurality of data voltages data[1] to data[m] according to the image data signal ImD to the plurality of data lines.

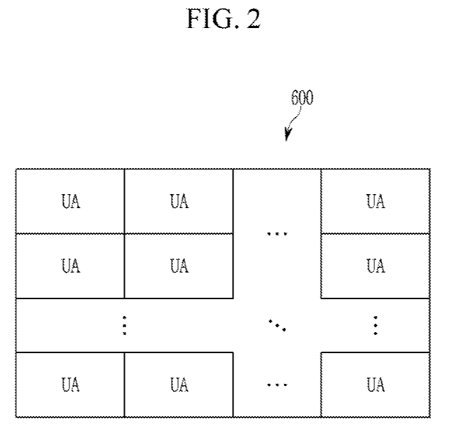

The plurality of pixels include high-level pixels and low-level pixels, and side visibility of the display device 10 may be improved by using the high-level pixels and the low-level pixels. In addition, a data line connection structure of the high-level pixel and the low-level pixel may be implemented as a structure for preventing occurrence of cross-talk and flicker in the display device 10. This will be described with reference to FIG. 2 to FIG. 5.

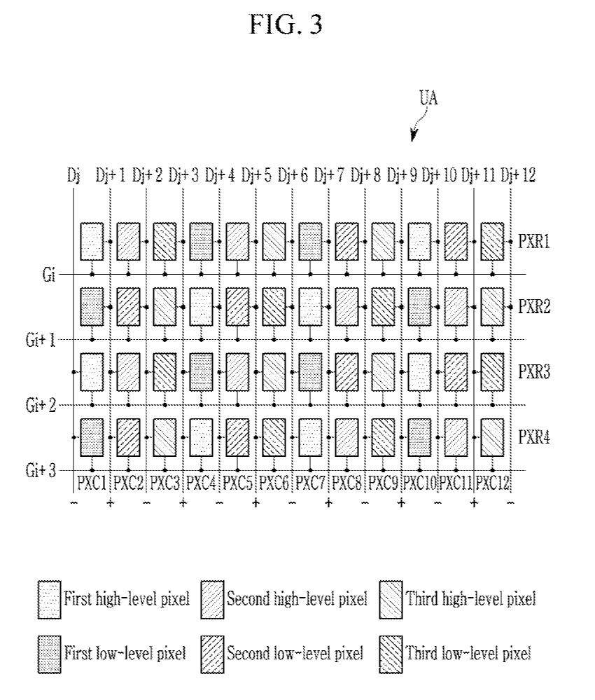

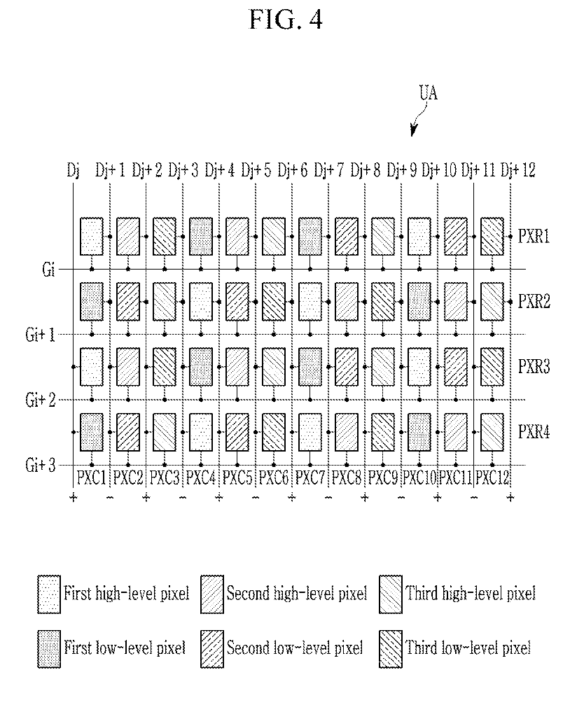

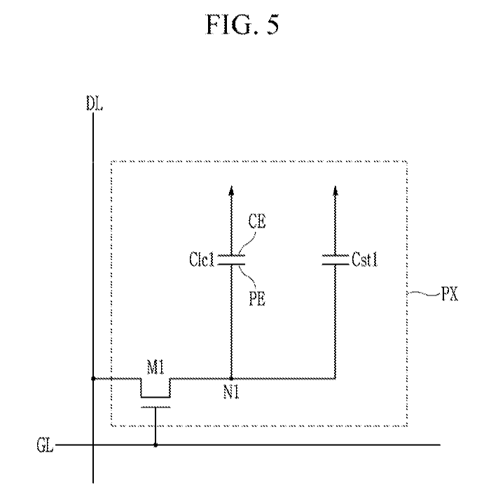

FIG. 2 is a block diagram of a plurality of unit areas of the display unit of FIG. 1. FIG. 3 shows a configuration of unit areas of the display unit according to the embodiment. FIG. 4 shows polarity inversion of a data voltage applied to a data line in the configuration of the unit areas of FIG. 3. FIG. 5 shows a pixel according to the embodiment.

Referring to FIG. 2, the display unit 600 includes a plurality of unit areas UA. In the display unit 600, the plurality of unit areas UA may be arranged in a row direction and a column direction, that is, in a matrix format (or array). The number of unit areas UA included in the display unit 600 is not particularly limited.

In FIG. 3 and FIG. 4, one of the unit areas UA included in the display unit 600 is illustrated. A connection relationship between configurations of other unit areas UA may be the same as the connection relationship between the configurations of the unit area UA shown in FIG. 3.

Each unit area UA includes a plurality of pixels arranged in a matrix format, a plurality of data lines Dj to D(j+12) connected to the plurality of pixels, and a plurality of gate lines Gi to G(i+3) connected to the plurality of pixels. Among the plurality of data lines Dj to D(j+12), the first data line Dj may be the same data line as the rightmost data line in a neighboring unit area UA. Alternatively, the last data line D(j+12) among the plurality of data lines Dj to D(j+12) may be the same data line as the leftmost data line in a neighboring unit area UA.

The plurality of pixels included in each unit area UA may be arranged in a 4 row×12 column matrix. That is, the plurality of pixels of each unit area UA may be arranged in a matrix having four pixels rows PXR1 to PXR4 and twelve pixel columns PXC1 to PXC12.

Each of plurality of pixels may be one of a high-level pixel and a low-level pixel. The high-level pixel is a pixel that receives a data voltage of relatively high luminance with respect to the same gray, and the low-level pixel is a pixel that receives a data voltage of relatively low luminance with respect to the same gray. That is, a gamma voltage applied to the high-level pixel and a gamma voltage applied to the low-level pixel may be different from each other.

The high-level pixel may be one of a first high-level pixel of a first color, a second high-level pixel of a second color, and a third high-level pixel of a third color. The low-level pixel may be one of a first low-level pixel of a first color, a second low-level pixel of a second color, and a third low-level pixel of a third color. The first color may be red, the second color may be green, and the third color may be blue. The first to third colors may be represented by a spatial or temporal combination, and a type of color is not restrictive.

The first high-level pixel may display the same color (e.g., red) as the first low-level pixel, but may display an image with relatively high luminance with respect to the same gray. The second high-level pixel may display the same color (e.g., green) as the second low-level pixel, but may display an image with relatively high luminance with respect to the same gray. The third high-level pixel may display the same color (e.g., blue) as the third low-level pixel, but may display an image with relatively high luminance with respect to the same gray.

The plurality of pixels may be alternately arranged in a row direction with the order of the first color, the second color, and the third color. A plurality of pixels of the same color may be arranged in a column direction. In addition, high-level pixel pairs (each consisting of two high-level pixels) and low-level pixel pairs (each consisting of two low-level pixels) may be alternately arranged in a row direction, and high-level pixels and low-level pixels may be alternately arranged in a column direction. For example, a first high-level pixel, a second high-level pixel, a third low-level pixel, a first low-level pixel, a second high-level pixel, a third high-level pixel, a first low-level pixel, a second low-level pixel, a third high-level pixel, a first high-level pixel, a second low-level pixel, and a third low-level pixel may be sequentially arranged in a row direction in a first pixel row PXR1. A first high-level pixel, a first low-level pixel, a first high-level pixel, and a first low-level pixel may be sequentially arranged in a column direction in the first pixel column PXC1, a second high-level pixel, a second low-level pixel, a second high-level pixel, and a second low-level pixel may be sequentially arranged in a column direction in a second pixel column PXC2, and a third low-level pixel, a third high-level pixel, a third low-level pixel, and a third high-level pixel may be sequentially arranged in a column direction in a third pixel column PXC3.

The plurality of gate lines Gi to G(i+3) may extend in a row direction along the corresponding pixel rows. For example, a first gate line Gi extends in a row direction corresponding to the first pixel row PXR1 and thus is connected with a plurality of pixels of the first pixel row PXR1, a second gate line G(i+1) extends in a row direction corresponding to the second pixel row PXR2 and thus is connected with a plurality of pixels of the second pixel row PXR2, a third gate line G(i+2) extends in a row direction corresponding to the third pixel row PXR3 and thus is connected with a plurality of pixels of the third pixel row PXR3, and a fourth gate line G(i+3) extends in a row direction corresponding to the fourth pixel row PXR4 and thus is connected with a plurality of pixels of the fourth pixel row PXR4.

Two corresponding data lines among data lines Di to D(j+12) are disposed at opposite sides of each of the plurality of pixel columns PXC1 to PXC12, and one data line may be disposed between neighboring pixel columns. The two data lines at opposite sides of each of the pixel columns PXC1 to PXC12 may be applied with data voltages having different polarities. For example, as shown in FIG. 3, a first data line Di disposed at a first side of the first pixel column PXC1 may be applied with a negative (-) data voltage, and a second data line D(j+1) disposed at a second side of the first pixel column PXC1 may be applied with a positive (+) data voltage. Here, the first side may imply the left side and the second side may imply the right side. A negative data voltage is applied to a third data line D(j+2) disposed at the second side of the second pixel column PXC2, and a positive data voltage may be applied to a fourth data line D(j+3) disposed at the second side of the third data line D(j+2). As described, a plurality of data voltages applied to the first data line Dj to the thirteenth data line D(j+12) may have polarity that is repeated in the order of negative (−), positive (+), negative (−), and positive (+).

Polarities of voltages applied a plurality of data lines Dj to D(j+12) may be inverted on a frame unit. For example, data voltages having polarities shown in FIG. 3 are applied to the plurality of data lines Dj to D(j+12) in a first frame, and a plurality of data voltages having polarities that are opposite to the polarities shown in FIG. 3 may be applied to the plurality of data lines Dj to D(j+12) in a second frame subsequent to the first frame.

For example, the plurality of data voltages applied to the first data line Dj to the thirteenth data line D(j+12) may have polarities that are repeated in the order of positive (+), negative (−), positive (+), and negative (−). In addition, a plurality of data voltages having the polarities shown in FIG. 3 may be applied to the plurality of data lines Dj to D(j+12) in a third frame subsequent to the second frame.

Each of the plurality of pixels may be connected to one of opposite data lines that are adjacent to the pixel. That is, each of the plurality of pixels may be connected to one of a data line of the first side and a data line of the second side. In this case, a plurality of pixels may be connected in the same direction of one of the first side and the second side in one pixel row. In addition, in two adjacent pixel rows, connection directions between a plurality of pixels and a plurality of data lines Dj to D(j+12) are the same as one of the first side and the second side, and connection directions between a plurality of pixels and a plurality of data lines Dj to D(j+12) in two other pixel rows that are adjacent to the two adjacent pixel rows may be the same as the other one of the first side and the second side.

That is, connection directions between a plurality of pixels and a plurality of data lines Dj to D(j+12) in two pixel rows PXR1 and PXR3 that are odd-numbered adjacent rows in a column direction are opposite to each other, and connection directions between a plurality of pixels and a plurality of data lines Dj to D(j+23) in two pixel rows PXR2 and PXR4 that are even-numbered adjacent rows in a column direction may be opposite to each other.

As shown in FIG. 3 and FIG. 4, a plurality of pixels of each of the first pixel row PXR1 and the second pixel row PXR2 are connected to a data line that is adjacent to the second side, and a plurality of pixels of each of the third pixel row PXR3 and the fourth pixel row PXR4 may be connected to a data line that is adjacent to the first side. Here, the first side may be the left side of each of the plurality of pixels, and the second side may be the right side of each of the plurality of pixels.

FIG. 5 shows a pixel PX connected to one gate line GL and one data line DL among a plurality of pixels included in each unit area UA. The pixel PX includes a switching transistor M1, a liquid crystal capacitor Clc1, and a sustain capacitor Cst1. The gate line GL may be one of the gate lines Gi to F(i+3) shown in FIG. 3 and FIG. 4, and the data line DL may be one of the data lines Di to D(j+12) shown in FIG. 3 and FIG. 4.

The switching transistor M1 includes a gate electrode connected to the gate line GL, a first electrode connected to the data line DL, and a second electrode connected to a first node N1.

The liquid crystal capacitor Clc1 includes a pixel electrode PE connected to the first node N1, and a common electrode CE where a common voltage is applied. A liquid crystal layer (not shown) having dielectric anisotropy may be disposed between the pixel electrode PE and the common electrode CE, and thus serves as a dielectric material. The pixel electrode PE receives a data voltage through the switching transistor M1, the common electrode CE receives a voltage of about 0 V or a common voltage of a predetermined voltage, and a pixel voltage is formed by a voltage difference between the pixel electrode PE and the common electrode CE. With reference to the common voltage, a data voltage higher than the common voltage may be a positive data voltage and a data voltage lower than the common voltage may be a negative data voltage.

The sustain capacitor Cst1 includes a first electrode connected to the first node N1 and a second electrode connected to a separate signal line. The common voltage or a predetermined voltage may be applied to the separate signal line. The sustain capacitor Cst1 serves to maintain the data voltage applied to the liquid crystal capacitor Clc1.

In such a pixel structure, when a data voltage is applied to the data line DL, coupling may occur between the data line DL and the pixel electrode PE and between the data line DL and the common electrode CE. Accordingly, crosstalk in which the pixel voltage is different from the desired value and the horizontal line or the vertical line is visible may occur. Alternatively, the number of positive pixels where a positive data voltage is applied and the number of negative pixels where a negative data voltage is applied are not the same for each frame, and thus a flicker in which a screen flickers may occur.

However, as shown in FIG. 3 and FIG. 4, the occurrences of the crosstalk and the flicker can be prevented by connecting the plurality of pixels and the plurality of data lines to each other.

Referring back to FIG. 3 and FIG. 4, in each unit area UA, the number of high-level pixels connected to a data line where a positive data voltage is applied, the number of high-level pixels connected to a data line where a negative data voltage is applied, the number of low-level pixels connected with a data line where a positive data voltage is applied, and the number of low-level pixels connected with a data line where a negative data voltage is applied are equal to each other.

Hereinafter, for better understanding and ease of description, a data line where a positive data voltage is applied will be referred to as a positive data line, and a data line where a negative data voltage is applied will be referred to as a negative data line.

As shown in FIG. 3 and FIG. 4, the number of first high-level pixels connected to the positive data line and the number of first high-level pixels connected to the negative data line are equally 4. The number of second high-level pixels connected to the positive data line and the number of second high-level pixels connected to the negative data line are equally 4. The number of third high-level pixels connected to the positive data line and the number of third high-level pixels connected to the negative data line are equally 4. The number of first low-level pixels connected to the positive data line and the number of first low-level pixels connected to the negative data line are equally 4. The number of second low-level pixels connected to the positive data line and the number of second low-level pixels connected to the negative data line are equally 4. The number of third low-level pixels connected to the positive data line and the number of third low-level pixels connected to the negative data line are equally 4. That is, the number of high-level pixels connected to the positive data line is 12, the number of high-level pixels connected to the negative data line is 12, the number of low-level pixels connected to the positive data line is 12, and the number of low-level pixels connected to the negative data line is 12.

In addition, the number of high-level pixels connected to the positive data line, the number of high-level pixels connected to the negative data line, the number of low-level pixels connected to the positive data line, and the number of low-level pixels connected to the negative data line are equal to each other in each of the pixel rows PXR1 to PXR4.

Further, the number of high-level pixels connected to the positive data line, the number of high-level pixels connected to the negative data line, the number of low-level pixels connected to the positive data line, and the number of low-level pixels connected to the negative data line are equal to each other in each of the pixel columns PXC1 to PXC12.

Particularly, regarding second high-level pixels and second low-level pixels that display green which requires high luminance in an image, the number of second high-level pixels connected to a positive data line, the number of second high-level pixels connected to a negative data line, the number of second low-level pixels connected to a positive data line, and a second low-level pixel connected to a negative data line are equally 1 in each pixel row (PXR1 to PXR4). In addition, in each of the second, fifth, eighth, and eleventh pixel columns PXC2, PXC5, PXC8, and PXC11, the number of second high-level pixels connected to a positive data line, the number of second high-level pixels connected to a negative data line, the number of second low-level pixels connected to a positive data line, and the number of second low-level pixels connected to a negative data line are equally 1. Accordingly, no luminance difference occurs between adjacent green pixel columns and no luminance difference occurs between adjacent green pixel rows, and thus crosstalk which causes a horizontal line or a vertical line to be viewed due to a green luminance difference can be prevented from occurring.

The number of high-level pixels connected to a positive data line, the number of high-level pixels connected to a negative data line, the number of low-level pixels connected to a positive data line, and the number of low-level pixels connected to a negative data line are equal to each other in a row direction, a column direction, and all unit areas UA. Even when polarities of data voltages applied to the plurality of data lines Dj to D(j+12) are inverted for frame units, such a rule is maintained. Accordingly, coupling between a data line and a pixel electrode, between a data line and a common electrode, and the like are offset by the above-described connection structure between the data line and the pixels so that crosstalk which causes a horizontal line or a vertical line to be viewed, or flickering on a screed frame by frame, may be prevented from occurring.

In addition, since data voltages of different levels of luminance are applied to the high-level pixel and the low-level pixel with respect to the same gray, a tilt angle of liquid crystal molecules in the high-level pixel and tilt angle of liquid crystal molecules in the low-level pixel become different from each other. An image from the side can therefore be seen as close as possible to the image from the front by adjusting a pixel voltage of the high-level pixel and a pixel voltage of the low-level voltage, thereby improving side visibility.

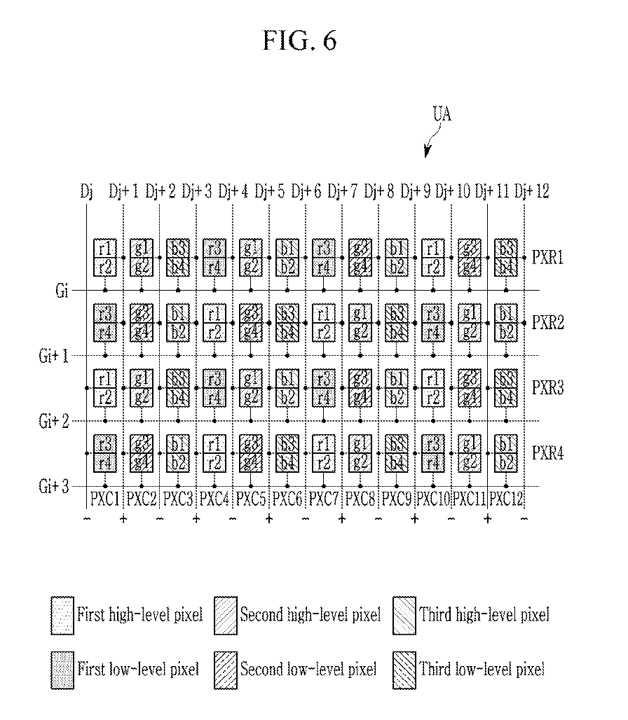

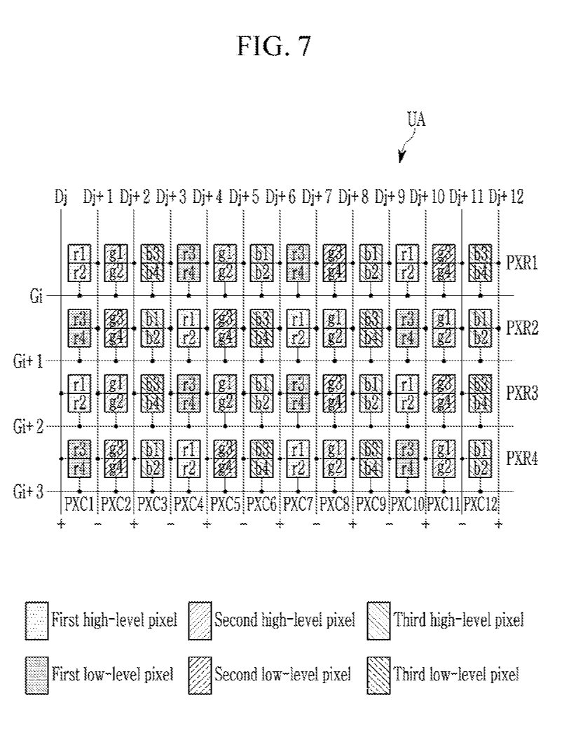

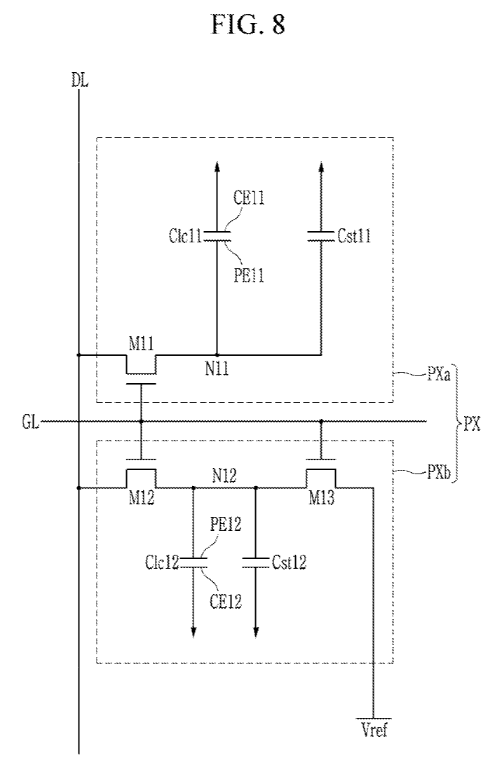

FIG. 6 shows a configuration of a unit area of a display unit according to an embodiment. FIG. 7 shows polarity inversion of data voltages applied to data lines in the configuration of the unit area of FIG. 6 according to an embodiment. FIG. 8 shows a pixel according to an embodiment.

Referring to FIG. 6 and FIG. 7, first high-level pixels are divided into first sub-pixels r1 of a first high level and second sub-pixels r2 of the first high level, and first low-level pixels are divided into first sub-pixels r3 of a first low level and second sub-pixels r4 of the first low level. In addition, second high-level pixels are divided into first sub-pixels g1 of a second high level and second sub-pixels g2 of the second high level, and second low-level pixels are divided into first sub-pixels g3 of a second low level and second sub-pixels g4 of the second low level. In addition, third high-level pixels are divided into first sub-pixels b1 of a third high level and second sub-pixels b2 of the third high level, and third low-level pixels are divided into first sub-pixels b3 of a third low level and second sub-pixels b4 of the third low level.

The first sub-pixel r1 of the first high level and the second sub-pixel r2 of the first high level are connected with the same gate line and data line such that they receive the same gate signal and the same data voltage. In addition, the first sub-pixel r3 of the first low level and the second sub-pixel r4 of the first low level are connected with the same gate line and data line so that they receive the same gate signal and the same data voltage.

The first sub-pixel g1 of the second high level and the second sub-pixel g2 of the second high level are connected with the same gate line and data line so that they receive the same gate signal and the same data voltage. In addition, the first sub-pixel g3 of the second low level and the second sub-pixel g4 of the second low level are connected with the same gate line and data line so that they receive the same gate signal and the same data voltage.

The first sub-pixel b1 of the third high level and the second sub-pixel b2 of the third high level are connected with the same gate line and data line so that they receive the same gate signal and the same data voltage. In addition, the first sub-pixel b3 of the third low level and the second sub-pixel b4 of the third low level are connected with the same gate line and data line so that they receive the same gate signal and the same data voltage.

In FIG. 6 and FIG. 7, for better understanding and ease of description, gate lines Gi, G(i+1), G(i+2), and G(i+3) are not respectively overlapped with the pixels, but this is not restrictive. The respective gate lines Gi, G(i+1), G(i+2), and G(i+3) may overlap pixels of the corresponding pixel rows PXR1, PXR2, PXR3, and PRX4. For example, the gate lines Gi, G(i+1), G(i+2), and G(i+3) may extend on a row direction across first sub-pixels r1, r3, g1, g3, b1, and b3 and second sub-pixels r2, r4, g2, g4, b2, and b4 included in one pixel.

First sub-pixels r1, r3, g1, g3, b1, and b3 and second sub-pixels r2, r4, g2, g4, b2, and b4 included in one pixel are charged with different pixel voltages even though they receive the same data voltage. This will be described with reference to FIG. 8.

FIG. 8 shows one pixel PX divided into a first sub-pixel PXa and a second sub-pixel PXb. The pixel PX may be one of a first high-level pixel, a first low-level pixel, a second high-level pixel, a second low-level pixel, a third high-level pixel, and a third low-level pixel. In addition, the first sub-pixel PXa may be one of the first sub-pixel r1, r3, g1, g3, b1, and b3 shown in FIG. 6 and FIG. 7, and the second sub-pixel PXb may be one of the second sub-pixels r2, r4, g2, g4, b2, and b4 shown in FIG. 6 and FIG. 7. A gate line GL connected to the pixel PX may be one of the gate lines Gi to G(i+3) shown in FIG. 6 and FIG. 7, and a data line DL may be one of data lines Dj to D(j+12) of FIG. 6 and FIG. 7.

The first sub-pixel PXa includes a first switching transistor M11, a first liquid crystal capacitor Clc11, and a first sustain capacitor Cst11. The first switching transistor M11 includes a gate electrode connected to the gate line GL, a first electrode connected to the data line DL, and a second electrode connected to a first node N11. The first liquid crystal capacitor Clc11 includes a first pixel electrode PE11 connected to the first node N11 and a first common electrode CE11 where a common voltage is applied. A first crystal layer (not shown) having dielectric anisotropy is disposed between first pixel electrode PE11 and the first common electrode CE11 and thus may serve as a dielectric material.

The second sub-pixel PXb includes a second switching transistor M12, a third switching transistor M13, a second liquid crystal capacitor Clc12, and a second sustain capacitor Cst12. The second switching transistor M12 includes a gate electrode connected to the gate line GL, a first electrode connected to the data line DL, and a second electrode connected to a second node N12. The third switching transistor M13 includes a gate electrode connected to the gate line GL, a first electrode connected to the second node N12, and a second electrode connected to a reference voltage Vref. The second liquid crystal capacitor Clc12 includes a second pixel electrode PE12 connected to the second node N12 and a second common electrode CE12 where a common voltage is applied. A first crystal layer (not shown) having dielectric anisotropy is disposed between second pixel electrode PE12 and the second common electrode CE12 and thus may serve as a dielectric material. The second common electrode CE12 may be the same electrode as the first common electrode CE11.

When a gate signal of a gate-on voltage is applied to the gate line GL, the first to third switching transistors M11, M12, and M13 are turned on. The data voltage applied to the data line DL is applied to the first pixel electrode PE11 of the first liquid crystal capacitor Clc11 through the first switching transistor M11, and is applied to the second pixel electrode PE12 of the second liquid crystal capacitor Clc12 through the second switching transistor M12. The first liquid crystal capacitor Clc11 and the second liquid crystal capacitor Clc12 are charged according to a voltage difference between the data voltage and the common voltage. In this case, a voltage charged in the second liquid crystal capacitor Clc12 is divided through the turned-on third switching transistor M13, and a voltage charged in the second liquid crystal capacitor Clc12 is lowered due to a difference between the common voltage and the reference voltage Vref. That is, a pixel voltage charged in the first liquid crystal capacitor Clc11 becomes higher than the pixel voltage charged in the second liquid crystal capacitor Clc12.

Since the pixel voltage of the first liquid crystal capacitor Clc11 and the pixel voltage of the second liquid crystal capacitor Clc12 are different from each other, tilt angles of liquid crystal molecules in the first sub-pixel PXa and the second sub-pixel PXb are different from each other, and as a result, luminances of the two sub-pixels PXa and PXb are different from each other. When the pixel voltage of the first liquid crystal capacitor Clc11 and the pixel voltage of the second liquid crystal capacitor Clc12 are appropriately controlled, an image viewed from the side may be maximally approximated to an image viewed from the front, thereby improving side visibility.

Referring back to FIG. 6 and FIG. 7, since the first high-level pixel, the first low-level pixel, the second high-level pixel, the second low-level pixel, the third high-level pixel, and the third low-level pixel have the pixel structure shown in FIG. 8, first sub-pixels r1, r3, g1, g3, b1, and b3 and second sub-pixels r2, r4, g2, g4, b2, and b4 included in one pixel may be charged with different pixel voltages even though they are applied with the same data voltage.

That is, even though the first sub-pixel r1 of the first high level and the second sub-pixel r2 of the first high level are applied with the same data voltage, the second sub-pixel r2 of the first high level may be charged with a pixel voltage that is lower than a pixel voltage charged to the first sub-pixel r1 of the first high level. Then, the first sub-pixel r1 of the first high level can display an image with relatively higher luminance than the second sub-pixel r2 of the first high level. Even though the first sub-pixel r3 of the first low level and the second sub-pixel r4 of the first low level are applied with the same data voltage, the second sub-pixel r4 of the first low level may be charged with a pixel voltage that is lower than a pixel voltage charged to the first sub-pixel r3 of the first low level. Then, the first sub-pixel r3 of the first low level can display an image with relatively higher luminance than the second sub-pixel r4 of the first low level. In this case, the first sub-pixel r3 of the first low level can display relatively lower luminance than the second sub-pixel r2 of the first high level.

In addition, even though the first sub-pixel g1 of the second high level and the second sub-pixel g2 of the second high level are applied with the same data voltage, the second sub-pixel g2 of the second high level may be charged with a pixel voltage that is lower than that of the first sub-pixel g1 of the second high level. Then, the first sub-pixel g1 of the second high level can display an image with luminance that is relatively higher than that of the second sub-pixel g2 of the second high level. Even though the first sub-pixel g3 of the second low level and the second sub-pixel g4 of the second low level are applied with the same data voltage, the second sub-pixel g4 of the second low level may be charged with a pixel voltage that is lower than a pixel voltage charged to the first sub-pixel g3 of the second low level. The first sub-pixel g3 of the second low level can display an image with relatively higher luminance than the second sub-pixel g4 of the second low level. In this case, the first sub-pixel g3 of the second low level can display an image with relatively lower luminance than that of the second sub-pixel g2 of the second high level.

Even though the first sub-pixel b1 of the third high level and the second sub-pixel b2 of the third high level are applied with the same data voltage, the second sub-pixel b2 of the third high level may be charged with a pixel voltage that is lower than a pixel voltage charged to the first sub-pixel b1 of the third high level. Then, the first sub-pixel b1 of the third high level can display an image with relatively higher luminance than the second sub-pixel b2 of the third high level. Even though the first sub-pixel b3 of the third low level and the second sub-pixel b4 of the third low level are applied with the same data voltage, the second sub-pixel b4 of the third low level may be charged with a pixel voltage that is lower than a pixel voltage charged to the first sub-pixel b3 of the third low level. The first sub-pixel b3 of the third low level can display an image with relatively higher luminance than the second sub-pixel b4 of the third low level. In this case, the first sub-pixel b3 of the third low level can display an image with relatively lower luminance than the second sub-pixel b2 of the third high level.

As described above, the first high-level pixel, the first low-level pixel, the second high-level pixel, the second low-level pixel, the third high-level pixel, and the third low-level pixel are respectively divided into first sub-pixels and second sub-pixels that are respectively charged with different pixel voltages, and accordingly, side visibility can be more improved.

Except for some differences, features described with reference to FIG. 1 to FIG. 4 can be applied to embodiments described with reference to FIG. 6 and FIG. 7.

While example embodiments have been described, practical embodiments are not limited to the described embodiments. Embodiments are intended to cover various modifications and equivalent arrangements included within the spirit and scope of the appended claims.

What is claimed is:

1. A display device comprising a display unit including a plurality of unit areas,
wherein each of the plurality of unit areas comprises a plurality of pixels arranged in a matrix format,
the plurality of pixels comprise a plurality of high-level pixels receiving a data voltage of relatively high luminance and a plurality of low-level pixels receiving a data voltage of relatively low luminance with respect to the same image data, and
in the unit areas, high-level pixel pairs and low-level pixel pairs are alternately arranged in a row direction, and one high-level pixel and one low-level pixel are alternately arranged in a column direction.

2. The display device of claim 1, wherein each of the plurality of unit areas further comprises a plurality of data lines connected to the plurality of pixels and extending along corresponding pixel columns, and
a plurality of pixels included in two adjacent pixel rows are respectively connected to a data line of a first side among two adjacent opposite data lines, and a plurality of pixels included in two other adjacent pixel rows that are adjacent to the two adjacent pixel rows are connected to a data line of the second side among the two adjacent opposite data lines.

3. The display device of claim 2, wherein each of the plurality of unit areas further comprises a plurality of gate lines each extending in a row direction for one pixel row and connected to the plurality of pixels, and each of the plurality of pixels connected to the same gate line is connected to a data line on the same side among the two adjacent opposite data lines.

4. The display device of claim 2, wherein polarities of data voltages applied to two adjacent opposite data lines of the pixel columns are different to each other.

5. The display device of claim 4, wherein the number of high-level pixels connected to a first data line where a positive data voltage is applied, the number of high-level pixels connected to a second data line where a negative data voltage is applied, the number of low-level pixels connected to the first data line, and the number of low-level pixels connected to the second data line are equal to each other.

6. The display device of claim 1, wherein each of the plurality of unit areas comprises a plurality of pixels arranged in a matrix of 4 rows and 12 columns.

7. The display device of claim 1, wherein the plurality of high-level pixels comprise a first high-level pixel displaying a first color, a second high-level pixel displaying a second color, and a third high-level pixel displaying a third color, and
the plurality of low-level pixels comprise a first low-level pixel displaying the first color, a second low-level pixel displaying the second color, and a third low-level pixel displaying the third color.

8. The display device of claim 7, wherein the plurality of pixels are arranged in an order of the first color, the second color, and the third color in the row direction, and are arranged by the same color in the column direction.

9. The display device of claim 7, wherein each of the first to third high-level pixels is divided into a first sub-pixel of a high level and a second sub-pixel of a high level connected to the same gate line and the same data line, and each of the first to third low-level pixels is divided into a first sub-pixel of a low level and a second sub-pixel of a low level connected to the same gate line and the same data line.

10. The display device of claim 9, wherein the first sub-pixel of the high level and the second sub-pixel of the high level receive the same gate signal and the same data voltage, and the second sub-pixel of the high level is charged with a relatively lower pixel voltage than the first sub-pixel of the high level.

11. The display device of claim 10, wherein the first sub-pixel of the low level and the second sub-pixel of the low level receive the same gate signal and the same data voltage, and the second sub-pixel of the low level is charged with a relatively lower pixel voltage than the first sub-pixel of the low level.

12. The display device of claim 11, wherein the first sub-pixel of the low level displays an image with luminance that is relatively lower than that of the second sub-pixel of the high level.

13. A display device comprising:
a first gate line to a fourth gate line that are extended in a first direction and adjacent to each other; and
a plurality of high-level pixels and a plurality of low-level pixels connected to the first to fourth gate lines,
wherein high-level pixel pairs and low-level pixel pairs are alternately arranged in the first direction and connected to the first and third gate lines,
low-level pixel pairs and high-level pixel pairs are alternately arranged in the first direction and connected to the second and fourth gate lines, and
the plurality of high-level pixels receive a data voltage of relatively higher luminance than the plurality of low-level pixels with respect to the same image data.

14. The display device of claim 13, further comprising a plurality of data lines connected to the plurality of high-level pixels and the plurality of low-level pixels,
wherein a plurality of high-level pixels connected to the first gate line are connected to the same data line to which a plurality of low-level pixels connected to the second gate line are connected,
a plurality of low-level pixels connected to the first gate line are connected to the same data line to which a plurality of high-level pixels connected to the second gate line are connected,
a plurality of high-level pixels connected to the third gate line are connected to the same data line to which a plurality of low-level pixels connected to the fourth gate line are connected, and
a plurality of low-level pixels connected to the third gate line are connected to the same data line to which a plurality of high-level pixels connected to the fourth gate line are connected.

15. The display device of claim 14, wherein a plurality of high-level pixels and a plurality of low-level pixels connected to the first gate line and the second gate line are respectively connected to a data line of a first side among two adjacent opposite data lines, and
a plurality of high-level pixels and a plurality of low-level pixels connected to the third gate line and the fourth gate line are connected to a data line of a second side among the two adjacent opposite data lines.

16. The display device of claim 13, wherein each of the plurality of high-level pixels is divided into a first sub-pixel of a high level and a second sub-pixel of a high level connected to the same gate line and the same data line, and
each of the plurality of low-level pixels is divided into a first sub-pixel of a low level and a second sub-pixel of a low level connected to the same gate line and the same data line.

17. The display device of claim 16, wherein the first sub-pixel of the high level and the second sub-pixel of the high level receive the same gate signal and the same data voltage, and the second sub-pixel of the high level is charged with a relatively lower pixel voltage than the first sub-pixel of the high level.

18. The display device of claim 17, wherein the first sub-pixel of the low level and the second sub-pixel of the low level receive the same gate signal and the same data voltage, and the second sub-pixel of the low level is charged with a relatively lower pixel voltage than the first sub-pixel of the low level.

19. A display device comprising a plurality of pixels arranged in a matrix format and a display unit including a plurality of data lines connected to the plurality of pixels,
wherein the display unit comprises:
a first pixel row including high-level pixel pairs and low-level pixel pairs that are connected to a data line of a first side among two opposite data lines and alternately arranged in a row direction;
a second pixel row including low-level pixel pairs and high-level pixel pairs that are connected to the data line of the first side among the two opposite data lines and alternately arranged in the row direction;
a third pixel row including high-level pixel pairs and low-level pixel pairs that are connected to a data line of a second side among the two opposite data lines and alternately arranged in a row direction; and
a fourth pixel row including low-level pixel pairs and high-level pixel pairs that are connected to the data line of the second side among the two opposite data lines and alternately arranged in the row direction, and
the high-level pixels among the plurality of pixels receive a data voltage of relatively higher luminance than the low-level pixels with respect to the same image data.

20. The display device of claim 19, wherein the high-level pixels are divided into a first sub-pixel of a high level and a second sub-pixel of a high level connected to the same gate line and the same data line, and the second sub-pixel of the high level is charged with a relatively lower pixel voltage than the first sub-pixel of the high level, and
the low-level pixels are divided into a first sub-pixel of a low level and a second sub-pixel of a low level connected to the same gate line and the same data line, and the second sub-pixel of the low level is charged with a relatively lower pixel voltage than the first sub-pixel of the low level.
